(19) United States
(12) Patent Application Publication
(10) Pub. No.: US 2025/0307653 A1
(43) Pub. Date: Oct. 2, 2025

(54) INFORMATION PROCESSING APPARATUS, DISPLAY CONTROL METHOD, AND STORAGE MEDIUM

(71) Applicant: NEC Corporation, Minato-ku, Tokyo (JP)

(72) Inventor: Darshit VAGHANI, Tokyo (JP)

(73) Assignee: NEC Corporation, Minato-ku, Tokyo (JP)

(21) Appl. No.: 18/864,081

(22) PCT Filed: May 16, 2022
(86) PCT No.: PCT/JP2022/020420

§ 371 Date: Nov. 8, 2024

(51) Int. Cl. G06N 3/0985; G06N 3/0464

(52) U.S. Cl. CPC G06N 3/0985; G06N 3/0464

(57) ABSTRACT

Technical Problem

To provide a time efficient Neural Architecture Search for the Backbone block of Computer Vision task.

Solution to Problem

A neural architecture searching apparatus comprises building means (11) to build a supernetwork, wherein a target layer of the supernetwork to be optimized is replaced by a plurality of candidate layers, and the supernetwork comprises a plurality of fully-connected layers; training means (12) to train the supernetwork, wherein the plurality of candidate layers are trained part by part, and the plurality of fully-connected layers are trained correspondingly to the part of the plurality of candidate layers; and selecting means (13) to evaluate the trained supernetwork and select a part of the plurality of candidate layers which corresponds to the best performing part of the plurality of fully-connected layers.

### TECHNICAL FIELD

The present application relates to a neural architecture searching apparatus, neural architecture searching method, and a program.

### BACKGROUND ART

In past couple of decades, the Convolutional Neural Network (CNN) models have become the state of the art solution for the computer vision task likes Image Classification, Object Detection, and Semantic Segmentation and so on. The primary reason for the success of the CNN models is capability to achieve high accuracy. In the real time application, the time taken for the execution of the CNN model commonly referred as execution time is also very vital.

High accuracy achieving CNN models tend to have several number of CNN layers while high speed (i.e. small execution time) achieving CNN models tend to have fewer CNN layers. Hence, there exists a trade between accuracy and speed w.r.t number of CNN layers employed in the CNN models. Additionally, there are several hyper-parameter associated with CNN layers, sample example being kernel size, input channel, output channel and so on. Manually optimizing each hyper-parameter for every layer is a time consuming task and requires lot of human expertise.

Recently, the efficient methodology for such a problem has evolved namely Neural Architecture Search (NAS). The NAS methodology generally involves 3 steps, initially a network consisting of several candidates of CNN layers is constructed as shown in FIG. 2. The large network with several candidate CNN layers is known as SuperNet. As a first step in the NAS, the SuperNet is trained on the dataset. Then, during the second step, the SuperNet is either intelligently pruned to become a smaller network having fewer CNN layers with the aim to have minimal accuracy degradation. The smaller network with fewer CNN layers is known as SubNet. At last, in the third step, the SubNet is further trained on the dataset to recover the accuracy.

The CNN model for the Object Detection task primarily consist of 3 blocks namely Backbone block, Neck block and Head block. The primary task of Backbone block is to perform shallow level feature extraction from input image, Neck block performs deeper level feature extraction and Head block performs task of predicting the labels based on the feature extracted by Backbone block and Neck block. The NAS method can be applied to one or more blocks. NAS eases the requirements of human expertise for designing a CNN model. However, the concerns with NAS methodology is time for training SuperNet, and for searching and training optimal SubNet is long. To tackle this concerns a Non-patent literature introduced special architecture parameter that are also trained during SuperNet. With the help of special architecture parameter SuperNet can be quickly pruned making 2nd step quicker and thereby making the NAS methodology faster. However, time required for training large SuperNet is quite long, which create large delay in obtaining final SubNet.

### CITATION LIST

### Non Patent Literature

### [NPL 1]

Fast Neural Network Adaptation via Parameter Remapping and Architecture Search, Jiemin Fang, Yuzhu Sun, Kangjian Peng, Qian Zhang, Yuan Li, Wenyu Liu, Xinggang Wang, https://arxiv.org/abs/2001.02525

### SUMMARY OF INVENTION

### Technical Problem

A problem in NAS is how to train SuperNet model, where SuperNet model consists of several layers and each layer has several candidates of convolutional layers, to make the size of CNN model large. Training such a large CNN model is time consuming.

Another problem is a large gap between the SuperNet and a SubNet structure. In the SuperNet, several candidates present in each layers are trained under the condition that several parallel layers exist in previous and next layers, whereas in the SubNet, only one or fewer layer CNN layers are present in previous and next layers.

An example aspect of the present invention is attained in view of the problem, and an example object is to provide a time efficient Neural Architecture Search for the Backbone block of Computer Vision task.

### Solution to Problem

In order to attain the object described above, a neural architecture searching apparatus comprises: building means to build a supernetwork, wherein a target layer of the supernetwork to be optimized is replaced by a plurality of candidate layers, and the supernetwork comprises a plurality of fully-connected layers; training means to train the supernetwork, wherein the plurality of candidate layers are trained part by part, and the plurality of fully-connected layers are trained correspondingly to the part of the plurality of candidate layers; and selecting means to evaluate the trained supernetwork and select a part of the plurality of candidate layers which corresponds to the best performing part of the plurality of fully-connected layers.

In order to attain the object described above, a neural architecture searching method comprises: building a supernetwork, wherein a target layer of the supernetwork to be optimized is replaced by a plurality of candidate layers, and the supernetwork comprises a plurality of fully-connected layers; training the supernetwork, wherein the plurality of candidate layers are trained part by part, and the plurality of fully-connected layers are trained correspondingly to the part of the plurality of candidate layers; and evaluating the trained supernetwork and selecting a part of the plurality of candidate layers which corresponds to the best performing part of the plurality of fully-connected layers.

In order to attain the object described above, a program causes a computer to serve as the neural architecture searching apparatus, said program causing the computer to serve as the building means, the training means, and the selecting means.

### Advantageous Effects of Invention

According to an example aspect of the present invention, it is possible to provide a time efficient Neural Architecture Search for the Backbone block of Computer Vision task.

### BRIEF DESCRIPTION OF DRAWINGS

FIG. 1 is a block diagram illustrating a configuration of the neural architecture searching apparatus according to the first example embodiment.

FIG. 2 is a flowchart showing a flow of the neural architecture searching method according to the first example embodiment.

FIG. 3 is a flow chart illustrating a flow of neural architecture searching method according to the first example embodiment.

FIG. 4 is a block diagram illustrating a configuration of the neural architecture search based CNN model training system according to the second example embodiment.

FIG. 5 is a diagram schematically illustrating an example of SuperNet CNN model with candidate search space.

FIG. 6 is a diagram illustrating SuperNet CNN model built by SuperNet builder 300 according to the second example embodiment.

FIG. 7 is a block diagram illustrating a internal structure of FC block according to the second example embodiment.

FIG. 8 is a flowchart illustrating a flow of neural architecture searching process performed by the system according to the second example embodiment.

FIG. 9 is a flowchart for illustrating a process performed by the SuperNet builder 300 according to the second example embodiment.

FIG. 10 is a flowchart for explaining a process performed by the STOC according to the second example embodiment.

FIG. 11 is a diagram illustrating the current training in step S403 of FIG. 10.

FIG. 12 is a diagram illustrating the current training in step S405 of FIG. 10.

FIG. 13 is another diagram illustrating the current training performed in step S403 of FIG. 10.

FIG. 14 is another diagram illustrating the current training performed in step S404 of FIG. 10.

FIG. 15 is a flowchart for explaining a process performed by the neural architecture selector according to the second example embodiment.

FIG. 16 is diagram illustrating the SuperNet CNN model built by SuperNet builder according to the third example embodiment.

FIG. 17 is a flowchart for illustrating a process performed by the SuperNet builder 300 according to the third example embodiment.

FIG. 18 is a flowchart for illustrating a process performed by the neural architecture selector 500 according to the third example embodiment.

FIG. 19 is a diagram illustrating the SuperNet CNN model built by SuperNet builder according to the fourth example embodiment.

FIG. 20 is a flowchart for illustrating a process performed by the SuperNet builder according to the fourth example embodiment.

FIG. 21 is a block diagram illustrating a hardware configuration according to the example embodiments.

### DESCRIPTION OF EMBODIMENTS

### First Example Embodiment

The following description will discuss details of a first example embodiment according to the invention with reference to the drawings. The first example embodiment is an example embodiment which serves as the basis of the subsequent example embodiments.

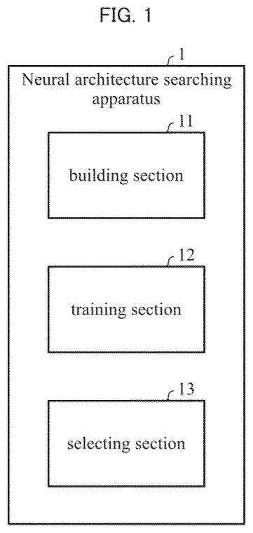

In the first example embodiment, a neural architecture searching apparatus and a neural architecture searching method are discussed with reference to FIG. 1 to FIG. 3.

### (Configuration of Neural Architecture Searching Apparatus)

The following description will discuss a configuration of a neural architecture searching apparatus 1 according to the first example embodiment with reference to FIG. 1. FIG. 1 is a block diagram illustrating a configuration of the neural architecture searching apparatus 1. As illustrated in FIG. 1, the neural architecture searching apparatus 1 includes a building section 11, a training section 12, and a selecting section 13.

The neural architecture searching apparatus 1 trains a large network (referred to as a super network) which contains a plurality of candidate network layers as optimization candidates. After training and optimization processes, the neural architecture searching apparatus 1 outputs a pruned network (also referred to as a sub-network) which is a smaller network than the supernetwork. The neural architecture searching apparatus 1 may also train the sub-network.

The feature building section 11 is an example of building means recited in claims. The training section 12 is an example of training means recited in claims. The selecting section 13 is an example of selecting means recited in claims.

The building section 11 builds a supernetwork. Here, as mentioned above, the supernetwork is a neural network which comprises a plurality of candidate network layers. The candidate network layers are the layers to be optimized in a optimization process by the neural architecture searching apparatus 1.

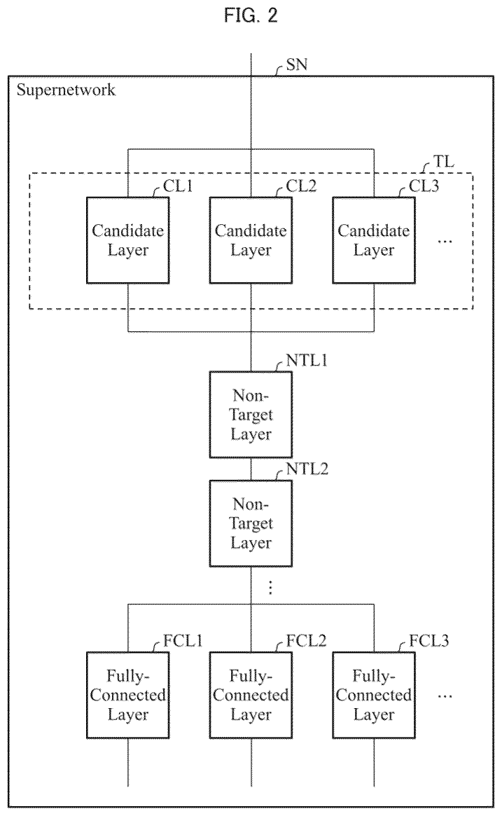

FIG. 2 is a schematic diagram illustrating a configuration of the supernetwork SN. As shown in FIG. 2, the supernetwork SN comprises one or more target layers (TL) and one or more non-target layers (NTL1, NTL2, . . . ). As shown in FIG. 2, the target layer of the supernetwork SN to be optimized is replaced by a plurality of candidate layers (CL1, CL2, CL3, . . . ).

Furthermore, as shown in FIG. 2, the supernetwork SN comprises a plurality of fully-connected layers (FCL1, FCL2, FCL3, . . . ). Each of these fully-connected layers may corresponds to each of candidate layers (CL1, CL2, CL3, . . . ).

When the supernetwork SN is trained, each of candidate layers (CL1, CL2, CL3, . . . ) included in the target layers (TL) is trained with a corresponding fully-connected layer (FCL1, FCL2, FCL3, . . . ).

That is, the training section 12 trains the supernetwork, wherein the plurality of candidate layers (CL1, CL2, CL3, . . . ) are trained part by part, and the plurality of fully-connected layers (FCL1, FCL2, FCL3, . . . ) are trained correspondingly to the part of the plurality of candidate layers.

When the supernetwork SN is trained, the loss on the supernetwork SN is evaluated using a pre-defined loss function. The candidate layers (CL1, CL2, CL3, . . . ) and the fully-connected layer (FCL1, FCL2, FCL3, . . . ) are selected with reference to the evaluation.

That is, the selecting section 13 evaluates the trained supernetwork and selects a part of the plurality of candidate layers (CL1, CL2, CL3, . . . ) which corresponds to the best performing part of the plurality of fully-connected layers (FCL1, FCL2, FCL3, . . . ).

### (Flow of Neural Architecture Searching Method)

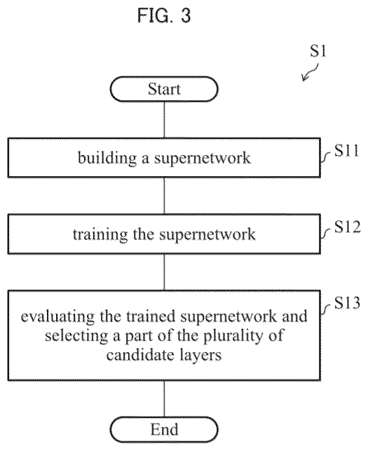

The following description will discuss a flow of neural architecture searching method according to the first example embodiment with reference to FIG. 3. FIG. 3 is a flow chart illustrating a flow of neural architecture searching method S1. As illustrated in FIG. 3, the flow of neural architecture searching method includes steps of S11-S13.

In step S11, a supernetwork SN is built by the building section 11 of the neural architecture searching apparatus 1. The supernetwork is a neural network which comprises a plurality of candidate network layers. The candidate network layers are the layers to be optimized in a optimization process by the neural architecture searching apparatus 1. That is, the neural architecture searching method S1 comprises a step of building a supernetwork, wherein a target layer of the supernetwork to be optimized is replaced by a plurality of candidate layers (CL1, CL2, CL3, . . . ), and the supernetwork comprises a plurality of fully-connected layers (FCL1, FCL2, FCL3, . . . ).

In step S12, the training section 12 trains the supernetwork as described above. That is, the neural architecture searching method S1 comprises a step of training the supernetwork, wherein the plurality of candidate layers (CL1, CL2, CL3, . . . ) are trained part by part, and the plurality of fully-connected layers (FCL1, FCL2, FCL3, . . . ) are trained correspondingly to the part of the plurality of candidate layers (CL1, CL2, CL3, . . . ).

In step S13, the selecting section 13 evaluates the trained supernetwork and selects a part of the plurality of candidate layers (CL1, CL2, CL3, . . . ) as described above. That is, the neural architecture searching method S1 comprises a step of evaluating the trained supernetwork and selecting a part of the plurality of candidate layers which corresponds to the best performing part of the plurality of fully-connected layers.

### Advantageous Effect of the First Example Embodiment

According to the first example embodiment, as mentioned above, the supernetwork is trained, where the plurality of candidate layers are trained part by part, and the plurality of fully-connected layers are trained correspondingly to the part of the plurality of candidate layers.

In this way, the training can be done quicker in comparison to a case where the all layers are trained simultaneously. This makes training time for the SuperNet very efficient Thus, a time efficient Neural Architecture Search for the Backbone block of Computer Vision task can be achieved.

### Second Example Embodiment

The following description will discuss details of a second example embodiment of the invention with reference to the drawings.

### (Configuration of Neural Architecture Search Based CNN Model Training System)

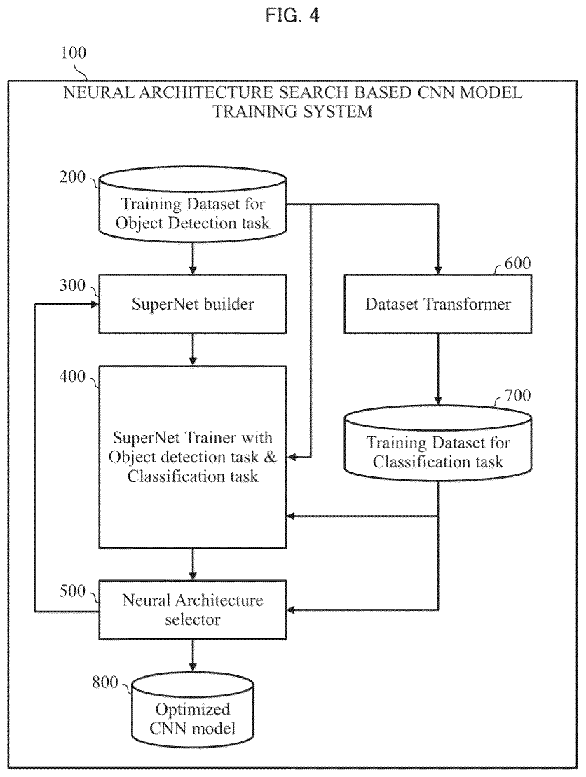

The following description will discuss a configuration of a neural architecture search based CNN model training system 100 according to the second example embodiment with reference to FIG. 4. FIG. 4 is a block diagram illustrating a configuration of the neural architecture search based CNN model training system 100. The CNN model is the supernetwork. In the following, the “supernetwork” may be also referred to as “SuperNet”. In the second example embodiment, the neural architecture search based CNN model that is trained by the neural architecture search based CNN model training system 100 is used for at least one of object detection task and object classification task.

As illustrated in FIG. 4, the neural architecture search based CNN model training system 100 includes training dataset for object detection task 200, a SuperNet builder 300, a SuperNet trainer with object detection task & classification task 400, and a neural architecture selector 500.

The training dataset for object detection task 200 is dataset provided for training the CNN model of the neural architecture search based CNN model training system 100 used in the object detection task. The training dataset for the object detection task 200 comprises of images and labels. Images are input and the labels are the prediction that a SuperNet and Subnet CNN model is intended to produce as output.

The SuperNet builder 300 corresponds to the building section 11 in the first example embodiment. The SuperNet trainer with object detection task & classification task 400 corresponds to the training section 12 in the first example embodiment. The neural architecture selector 500 corresponds to the selecting section 13 in the first example embodiment.

As explained in the first example embodiment, the SuperNet trainer with object detection task & classification task 400 trains the SuperNet, wherein the plurality of candidate layers are trained part by part, and the plurality of fully-connected layers are trained correspondingly to the part of the plurality of candidate layers. In this embodiment, a more specific case is described, in which the plurality of candidate layers and the corresponding fully-connected layers are trained one by one.

The neural architecture search based CNN model training system 100 further comprises a dataset transformer 600, training dataset for classification task 700 and an optimized CNN model 800.

The training dataset for the classification task 700 includes images and labels. Images are input and the labels are categories of objects present in the respective images. The labels are the prediction that a SuperNet during the classification task based training intended to produce as output.

The optimized CNN model 800 is obtained through the training of the SuperNet trainer with object detection task & classification task 400 and the selection of the neural architecture selector 500.

### (Data Transformer 600)

The dataset transformer 600 is a functional block served as a transforming means by performing a transformation from the training dataset for object detection task into the training dataset for classification task. The training dataset for classification task 700 is dataset for training the CNN model of the neural architecture search based CNN model training system 100 used in the classification task.

The dataset transformer 600 comprises means to receive the object detection dataset, a means to convert object detection dataset to classification dataset and a means to provide the classification dataset as output Since the means required to convert the object detection dataset into the classification dataset is mere engineering task and therefore not explained in the present description.

Thus, the neural architecture search based CNN model training system 100 includes a transforming means to transform the object detection dataset to the classification dataset.

### (SuperNet CNN Model and SuperNet Builder 300)

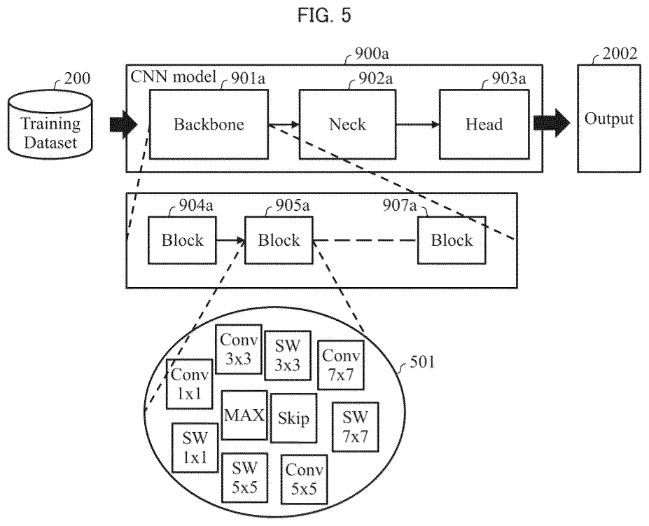

FIG. 5 schematically illustrates an example of a SuperNet CNN model with candidate search space. The SuperNet CNN model 900a includes a backbone 901a, Neck 902a, and head 903a. Details of the backbone 901a are illustrated as blocks (block 904a, 905a, . . . 907a). For example, the backbone 901a includes N blocks.

Each of the blocks may be formed by various types of neural architecture, such as Conv 3×3, SW 3×3, MAX, Skip. In FIG. 5, although only the detail of the block 905a is illustrated, the other blocks may also have the detailed structure. Conventionally, in the training of the CNN model is performed by using various types of neural architecture for the respective blocks (block 904a, 905a, . . . 907a). Such a training is however time consuming and inefficient. In this example embodiment, candidates for replacing the respective blocks are prepared.

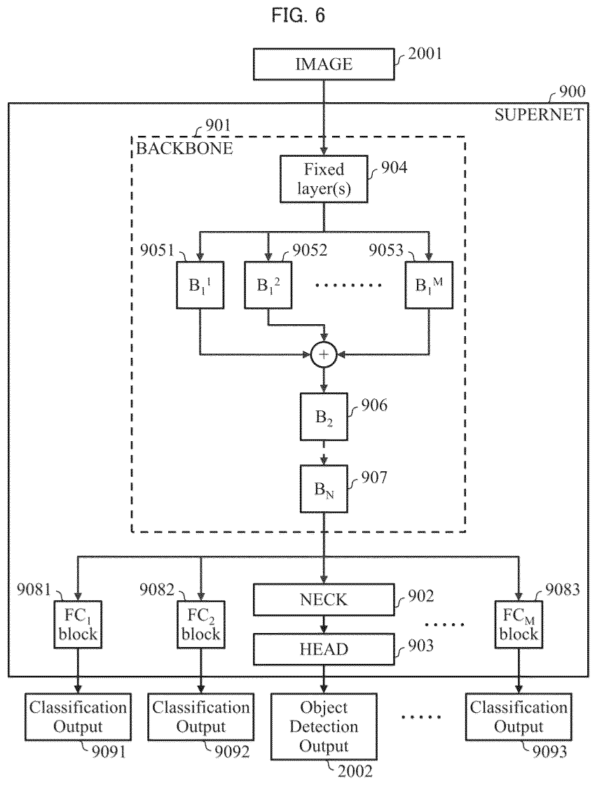

FIG. 6 is a block diagram illustrating SuperNet CNN model built by SuperNet builder 300. The SuperNet builder 300 comprises means to receive the training dataset for object detection task 200 and SuperNet, and means to build SuperNet. If the system 100 is performing iteration other than the first iteration, then the SuperNet is received from neural architecture selector 500. The SuperNet builder 300 then uses the pre-built SuperNet and modify it. If the system 100 is performing the first iteration, the SuperNet builder 300 builds the SuperNet as shown in FIG. 6 from scratch.

In FIG. 6 an image 2001 is input to the SuperNet CNN model 900.

F number of CNN layers are arranged in sequential which are referred as fixed layers 904.

N sequential CNN layers are arranged at the output of the last fixed layer 904. This N sequential CNN layers are referred to as Bᵢ, where i is index and 0<i≤N in FIG. 6. In this case, B₁ layer to B_{N} layer are sequentially arranged. At the output of the B_{N} layer, M parallel FC (fully-connected layers) blocks 9081 to 9083 of same structure are arranged completing the backbone 901 construction of the SuperNet.

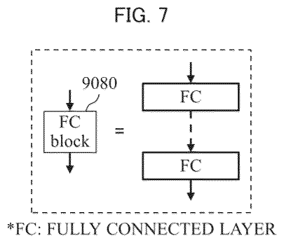

FIG. 7 is a block diagram illustrating a internal structure of FC block 9080. As illustrated in FIG. 7, the FC blocks 9081 to 9083 are basically sequentially arranged one or many fully connected layers.

Finally at the output of the B_{N} layer, Neck 902 and Head 903 are arranged as shown in FIG. 6. The Neck 902 and Head 903 are designed as per the requirement of the object detection task. The output of the Head 903 is therefore provided to the object detection output 2002. Meanwhile the outputs of FC blocks 9081 to 9083 are respectively provided to the Classification Outputs 9091 to 9093.

In FIG. 6 an image 2001 is input to the SuperNet CNN model 900. The image 2001 is firstly input in the fixed layer(s) 904 in the backbone 901. The fixed layer(s) 904 is connected to a plurality of sublayers (B₁¹, B₁², . . . , B₁^{M}). The plurality of sublayers (B₁¹, B₁², . . . , B₁^{M}) corresponds to the plurality of candidate layers (CL1, CL2, CL3, . . . ) in the first example embodiment.

At first, starting with the optimization of the B₁ layer, B₁ layer is replaced by M parallel CNN layers, which are also referred to as sublayers, being arranged as shown in FIG. 6. This M parallel CNN sublayers are given as B₁^{j}, where 0<j≤M. The M sublayers are basically several variants of CNN layers with varying hyper-parameter. One out of M sublayer will be selected during the selection performed by neural architecture selector 500 as a winner, and the remaining M−1 sublayers will be dropped.

The output from the last fixed layer 904 is input to all M parallel sublayers as shown in FIG. 6. The output of all M parallel are merged together by, but not limited to, an operation like concatenation or sum, and the output is fed as input to B₂ layer. Layer B₂ to B_{N} have only one CNN layer for each of the iterations for training the respective M parallel sublayers. The training will be discussed later in detail.

The layer for the optimization is also referred to as a target layer. In this case, the B₁ layer is the target layer. The target layer may be changed from B₁ layer to B_{N} layer. As described above, M parallel FC (fully-connected layers) blocks 9081 to 9083 are connected at the output of the B_{N} layer. Thus, the plurality of fully-connected layers are connected to an output of the target layer or any deeper layer compared to the target layer.

The B_{N} layer is connected to the Neck 902, and the Neck 902 is connected to the Head 903. The output of the Head 903 is shown as an object detection output 2002. Thus, in case of the object detection, the Neck 902 and the Head 903, as well as N layers of the backbone 901, are used for prediction.

Also, B_{N} layer is connected to the M parallel FC blocks 9081 to 9083. The output of the FC₁ block 9081 is shown as classification output 9091. Likewise, the output of the FC₂ block and the output of the FC₃ block 9081 are shown as a classification output 9092 and a classification output 9093. Thus, in case of the object classification, the FC blocks, as well as N layers of the backbone 901, are used for prediction.

(SuperNet Trainer with Object Detection Task & Classification Task 400)

The SuperNet Trainer with Object Detection task & Classification task 400 may be also referred as STOC 400. The STOC 400 comprises means to receive the training dataset for object detection task 200 and the training dataset for classification task 700, and means to receive SuperNet from the SuperNet builder 300. The STOC 400 also comprises the means to perform training of the SuperNet for the object detection task as well as classification task. Finally the STOC 400 also comprises means to output trained SuperNet.

The basic functionality of the STOC 400 is to train all M sublayers in the Bᵢ layer along with other Bₖ (0<k≤N; i≠k) layers with object detection task and train all FC blocks 9080 with classification task. Training of all sublayers in Bᵢ layers is done one by one. Similarly, training of all FC blocks is done one by one. Also the training of a sublayer and a FC block is done alternatively. In other words, firstly Bᵢ¹ sublayer 9051 will be trained with object detection task, then FC₁ block 9081 will be trained with classification task. Next, Bᵢ² sublayer 9052 will be trained with object detection task, then FC2 block 9082 will be trained with classification task and so on. Thus, the STOC 400 trains the supernetwork for at least one of an object detection task by using object detection dataset, and classification task by using classification dataset.

### (Neural Architecture Selector 500)

The neural architecture selector 500 comprises a means to receive trained SuperNet and classification dataset (training dataset for classification task 700) as input, a means to evaluate loss function on the SuperNet and a means to prune SuperNet and finally a means to output pruned SuperNet. The pruned SuperNet is also referred as SubNet.

In this example embodiment, the neural architecture search based CNN model training system 100 performs NAS (Neural Architecture Search) method for backbone 901. However, the neural architecture search based CNN model training system 100 can be easily extended to Neck 902 and Head 903 without significant effort.

Hereinafter, the neural architecture search based CNN model training system 100 may be also simply referred to the system 100.

### (Flow of Neural Architecture Searching Process Performed by System 100)

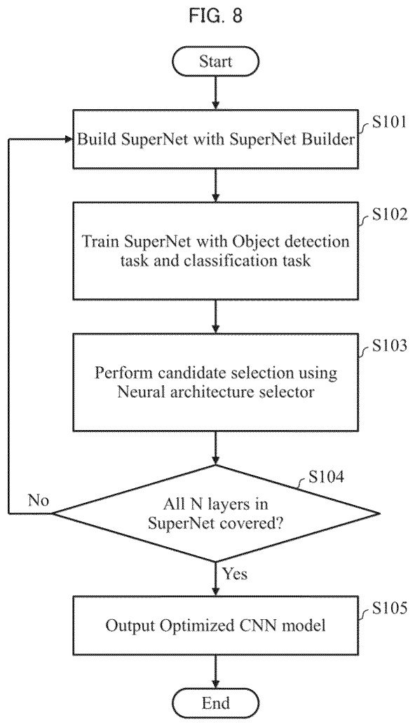

FIG. 8 is a flowchart illustrating a flow of neural architecture searching process performed by the system 100 in the second example embodiment.

In step S101, the system 100 builds the SuperNet with the SuperNet builder 300. The process performed by the SuperNet builder 300 will be discussed below in detail.

In step S102, the system 100 trains SuperNet with the SuperNet trainer with object detection task & classification task 400. The process performed by the SuperNet trainer with object detection task & classification task 400 will be discussed below in detail.

In step S103, the system 100 performs candidate selection using the neural architecture selector 500. Through this step, a sublayer is selected from the M parallel sublayers, thereby optimizing the target layer. The process performed by the neural architecture selector 500 will be discussed below in detail.

In step S104, the system 100 determines whether all N layers in the SuperNet have been optimized, or covered. If not, the value of the parameter i and a pruned SuperNet from the neural architecture selector 500 is provided as input to the SuperNet builder 300 for the next iteration. The system 100 thus performs the next iterations.

The processes of steps S101 to S104 are performed iteratively until it is determined that all N layers in the SuperNet have been covered in step S104.

If it is determined that all N layers in the SuperNet have been covered in step S104, the process of step of S105 is performed. In step S105, the system 100 outputs the optimized CNN model 800.

That is, the system 100 performs such iterations N times to cover all N layers of the SuperNet. In each iteration, the target layer is set. For example, in the first iteration, the target layer is B₁ layer. In the second iteration, the target layer is B₂ layer. Finally at the end of Nₜₕ iteration, where the target layer is B_{N} layer, the final pruned SuperNet from neural architecture selector 500 is given as output.

If needed, the pruned SuperNet may be trained for one or more epochs to improve accuracy, by the STOC 400 using the means to train SuperNet on object detection task. The final pruned SuperNet is also referred to as optimal SubNet or optimal CNN model, which is the output of the system 100.

During the SuperNet optimization, since only one layer is targeted at a time, a quicker search can be done in comparison to simultaneous optimization of all layers. Also, apart from the one preceding and one succeeding layer of target layer Bᵢ in a particular iteration, all other N−2 layers including the sublayers in Bᵢ gets trained with one layer as input and one layer as output. Such is generally the architecture structure of output Subnet or output Optimal CNN model.

### (Process Performed by SuperNet Builder 300)

When the system 100 is performing the first iteration of building the SuperNet (supernetwork), then SuperNet is built from scratch as shown in FIG. 6. If the system 100 is performing iteration other than the first iteration, then the SuperNet is received from neural architecture selector 500. The SuperNet builder 300 then uses the pre-built SuperNet and modify it.

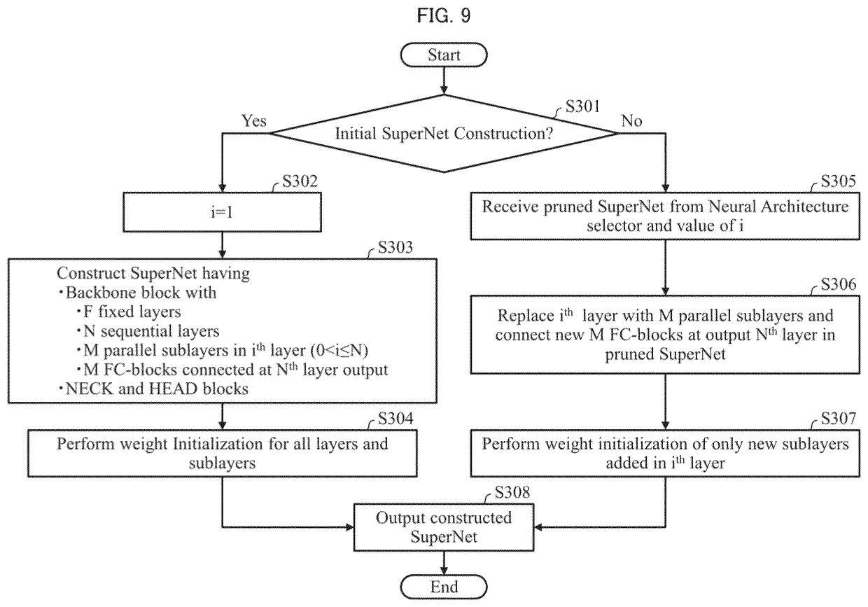

FIG. 9 is a flowchart for illustrating a process performed by the SuperNet builder 300.

In step S301, the SuperNet builder 300 determines whether the current process is performed as initial SuperNet construction. The initial SuperNet construction corresponds to the first iteration. In a case where the SuperNet builder 300 determines that the current process is performed as initial SuperNet construction, the process of step S302 is performed.

In step S302, the SuperNet builder 300 sets the value of the parameter i to be “1”.

In step S303, the SuperNet builder 300 constructs a SuperNet having the back bone 901 Neck 902, and Head 903, where the backbone 901 having F fixed layers, N sequential layers, M parallel sublayers in i^{th} layer (0<i≤N) M FC-blocks connected at N^{th} layer output. That is, the SuperNet builder 300 builds the SuperNet CNN model as explained with reference to FIG. 6.

In step S304, the SuperNet builder 300 performs a weight initialization for all layers and sublayers.

There are several options for the weight initialization. The sample example of weight initialization, but not limited to, are random initialization, parameter remapping, Xavier initialization and so on. The weight initialization task can also be done in the STOC 400 if needed.

The built and weight initialized SuperNet is given as the output in step S308 of FIG. 9.

In a case where the SuperNet builder 300 determines, in step S301, that the current process is not performed as initial SuperNet construction, then step S305 is performed. In this case, the system 100 is performing the second or subsequent iteration of building the SuperNet.

In step S305, the SuperNet builder 300 receives pruned SuperNet from the neural architecture selector 500 and value of the parameter i. The SuperNet from the previous iteration is also referred to as pruned SuperNet. The pruned SuperNet is the output of neural architecture selector 500. The received SuperNet from the neural architecture selector 500 has one layer in all N sequential layers. Also information about the next Bᵢ layer to be optimized is received in terms of value of the parameter i from the neural architecture selector 500.

In step S306, the SuperNet builder 300 replaces iₜₕ layer with M parallel sublayers and connects new M FC-blocks at output of the Nₜₕ layer in pruned SuperNet. In the received SuperNet, the Bᵢ layer is replaced by M parallel sublayers whereas remaining N−1 layers are kept as they are.

In step S307, the SuperNet builder 300 performs a weight initialization of only new sublayers added in iₜₕ layer. The weight initialization of all newly added M sublayers arranged in the Bᵢ layer is performed.

The modified SuperNet is then given as output of the SuperNet builder 300 in step S308 of FIG. 9. The output SuperNet is provided to the STOC 400.

Thus, the process of the SuperNet builder 300 is performed.

(Process Performed by SuperNet Trainer with Object Detection Task & Classification Task 400)

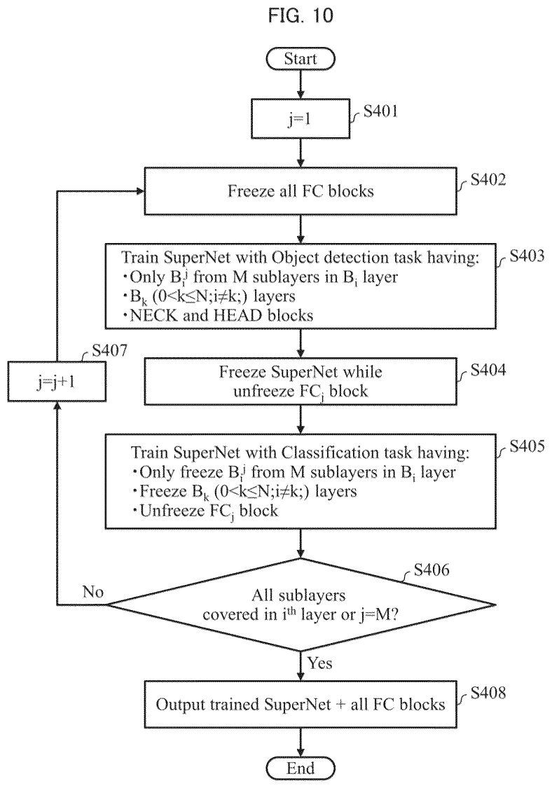

FIG. 10 is a flowchart for explaining a process performed by the STOC 400.

In step S401, the STOC 400 sets the parameter j to be “1”.

In step S402, the STOC 400 freezes all FC blocks. Initially weights of all the FC blocks 9080 are frozen, which means that weights will not change during the training of SuperNet with the object detection task in the step S402.

In step S403, the STOC 400 trains SuperNet with object detection task, where the SuperNet has only Bij from m sublayers in Bi layer, Bk (0<k≤N; i≠k) layers, and the Neck 902 and the Head 903.

The SuperNet is now trained on the training dataset 200 with the object detection task. During the SuperNet training, only B₁¹ sublayer 9051 participates among all M sublayers in B₁ layer. In other words, during the forward and back propagation only the B₁¹ sublayer 9051 participates from the M sublayers in B1 layer along with the other Bₖ (0<k≤N; i≠k) layers in the backbone 901, and Neck 902 and Head 903. Remaining M−1 sublayers in the B1 do not participate during the training.

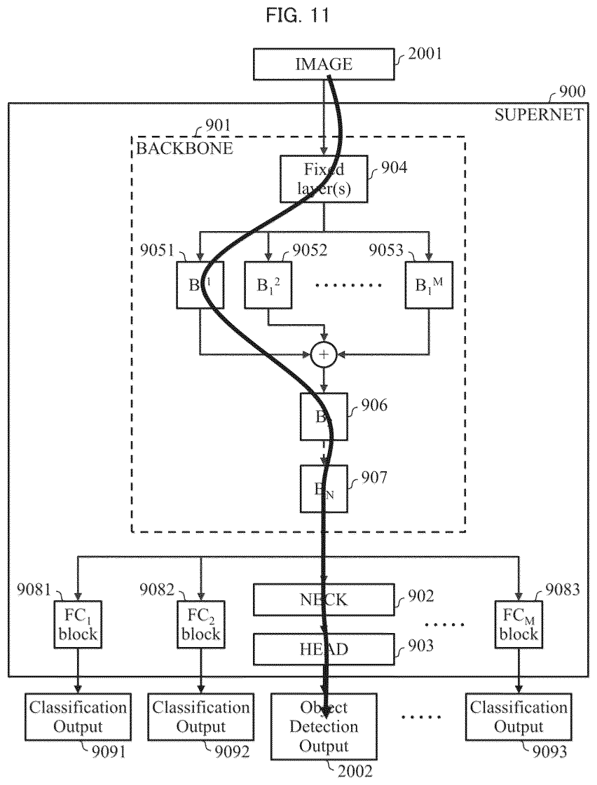

FIG. 11 illustrates the current training in step S403 of FIG. 10 performed for the first time. In this case, the sublayer B₁¹ in forward propagation during the object detection task based training phase of SuperNet model in the first iteration is shown. In FIG. 11, the curved thick line arrow is depicted so as to specify the blocks used in the current training. In FIG. 11, the curved thick line arrow passes through the fixed layer 904, B₁¹ sublayer 9051, B₂ layer 906 to B_{N} layer 907, the Neck 902, the head 9903 and the object detection output 2002.

In step S404, the STOC 400 freezes the weights of entire SuperNet while the STOC 400 unfreezes the weight of the FC₁ block 9081. Then, the SuperNet is trained on Classification task. During the training, only B₁¹ sublayer 9051 from the M sublayers in B₁ layer, as well as FC₁ block 9081 and other Bₖ (0<k≤N; i≠k) layers participate.

In step S405, the STOC 400 trains SuperNet with Classification task, where the SuperNet has only frozen Bᵢ^{j} from M sublayers in Bᵢ layer, frozen Bₖ (0<k≤N; i≠k) layers, and unfrozen FCⱼ block.

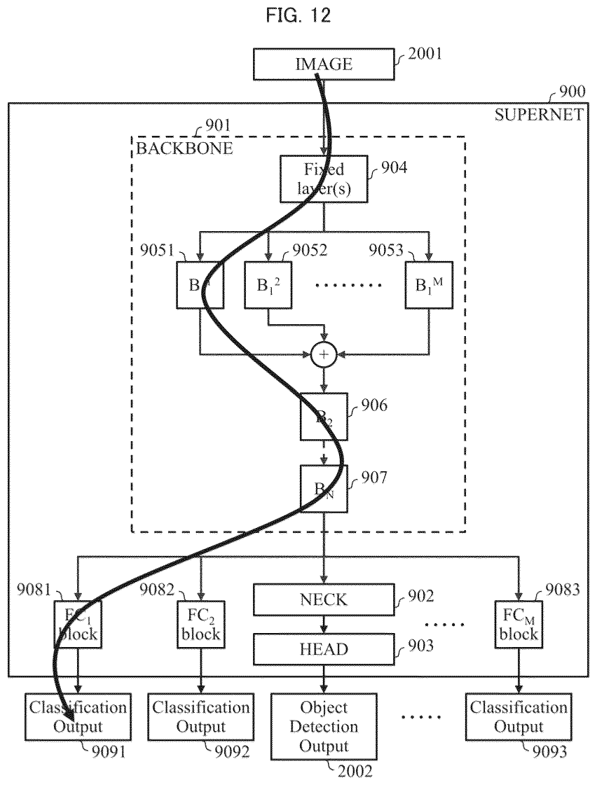

FIG. 12 illustrates the current training in step S405 of FIG. 10 performed for the first time. In this case, the sublayer B₁¹ in forward propagation during the classification task based training phase of FC blocks in the first iteration is shown. In FIG. 12, the curved thick line arrow is depicted so as to specify the blocks used in the current training. In FIG. 12, the curved thick line arrow passes through the fixed layer 904, B₁¹ sublayer 9051, B₂ layer 906 to B_{N} layer 907, the FC₁ block 9081 and the classification output 9091. In this case, during the training, only the weight of FC₁ block 9081 is updated.

In this way, the training explained with reference to FIG. 11 and FIG. 12 are performed for each of the sublayers.

In step S406, the STOC 400 determines whether all sublayers in the iₜₕ layer are covered or the value of the parameter j is equal to M. In a case where the STOC 400 determines that all sublayers in the iₜₕ layer are not covered nor the value of the parameter j is equal to M, the step S407 is performed. In step S407, the STOC 400 increments the value of the parameter j by “1”. Then, the processes of steps S402 to S406 are performed again.

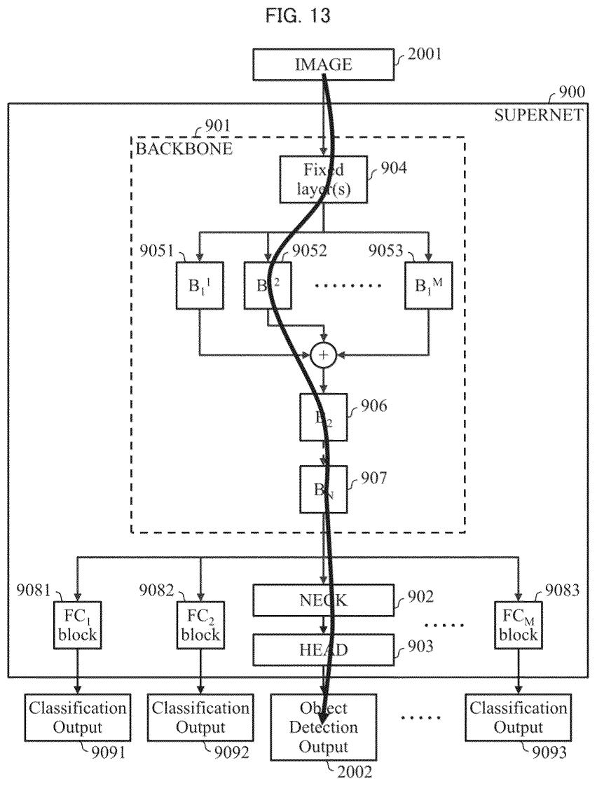

FIG. 13 illustrates the current training performed in step S403 of FIG. 10 performed for the second time. In this case, the sublayer B₁² in forward propagation during the object detection task based training phase of SuperNet model in the first iteration is shown. In FIG. 13, the curved thick line arrow is depicted so as to specify the blocks used in the current training. In FIG. 13, the curved thick line arrow passes through the fixed layer 904, B₁² sublayer 9052, B₂ layer 906 to B_{N} layer 907, the Neck 902, the head 9903 and the object detection output 2002.

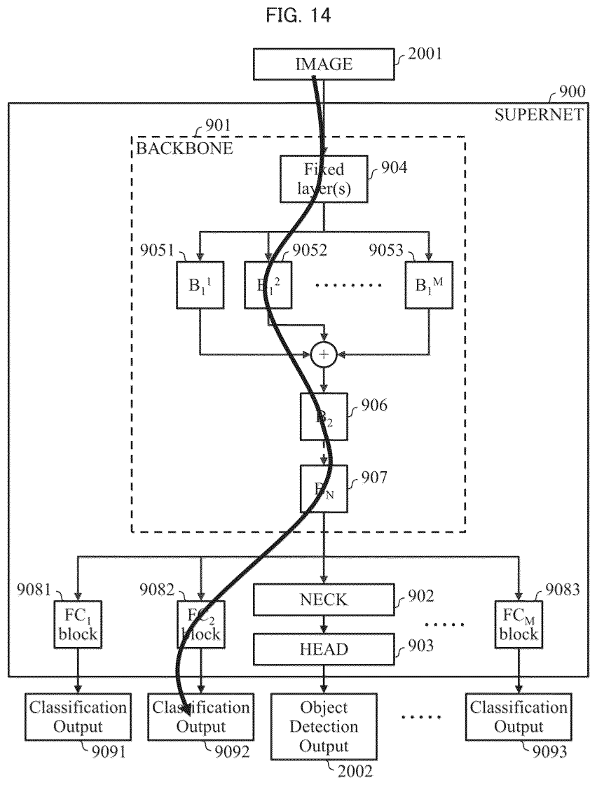

FIG. 14 illustrates the current training performed in step S404 of FIG. 10 performed for the second time. In this case, the sublayer B₁² in forward propagation during the classification task based training phase of FC blocks in the first iteration is shown. In FIG. 14, the curved thick line arrow is depicted so as to specify the blocks used in the current training. In FIG. 14, the curved thick line arrow passes through the fixed layer 904, B₁² sublayer 9052, B₂ layer 906 to B_{N} layer 907, the FC₂ block 9082 and the classification output 9092. In this case, during the training, only the weight of FC₂ block 9081 is updated.

The processes of steps S402 to S406 are repeatedly performed until the STOC 400 determines that all sublayers in the iₜₕ layer are covered or the value of the parameter j is equal to M. This means that the process of training SuperNet by involving one sublayer from Bᵢ layer at a time for the object detection task and involving one corresponding FC block at a time for the classification task is iteratively performed for M−1 number times for other M−1 sublayers and M−1 FC blocks.

Thus, in a training process by the STOC 400, the plurality of candidate layers are trained one by one, and the plurality of fully-connected layers are trained correspondingly to the one of the plurality of candidate layers.

After M iteration of SuperNet training with object detection and classification task, in step S408, the trained SuperNet and all FC blocks are output. This completes the step S102 shown in FIG. 3 performed for training the SuperNet partially with object detection task and partially with classification task.

The Trained SuperNet is input to the neural architecture selector 500, and the neural architecture selector 500 performs selection of sublayer explained as the step S103 in FIG. 8.

Thus, the process of the STOC 400 is performed.

### (Process Performed by Neural Architecture Selector 500)

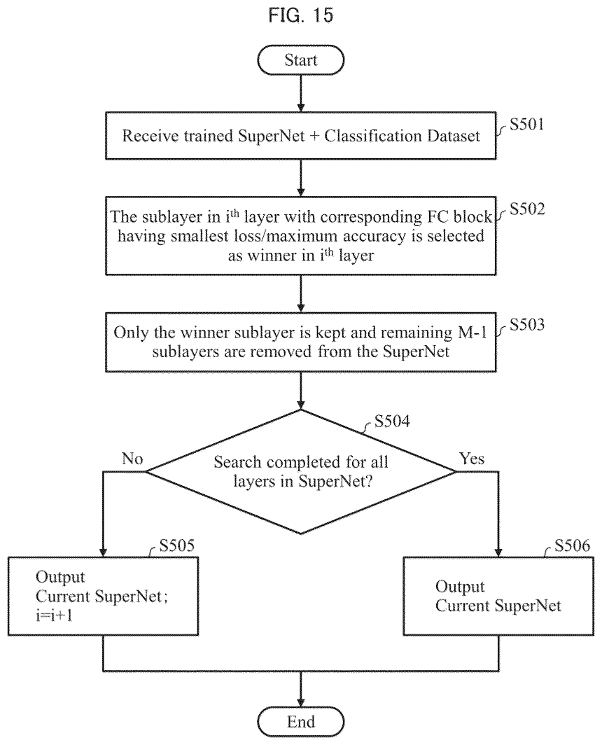

FIG. 15 is a flowchart for explaining a process performed by the neural architecture selector 500.

In step S501, the neural architecture selector 500 receives the trained SuperNet from the STOC 400. Also, the neural architecture selector 500 receives the training dataset for classification task 700 from the dataset transformer 600.

In step S502, the neural architecture selector 500 selects the sublayer in iₜₕ layer with corresponding FC block having smallest loss/maximum accuracy is selected as the winner in iₜₕ layer.

Firstly, the loss is evaluated using pre-defined loss function using output of the FC₁ block 9081 and the ground truth labels from the training dataset for classification task 700. During evaluation of loss at output FC₁ block 9081, only Bᵢ¹ sublayer in B₁ layer along with other Bₖ (0<k≤N; i≠k) layers and FC₁ block 9081 participate.

The definition of loss function may vary depending upon the objective of the NAS. If the objective is only achieving high accuracy then, the definition of loss function may only comprise of classification loss as expressed in formula (1) below.

$$\begin{matrix}[ Math . 1 ] & \\ Loss = {f}_{l} ( classification loss ) & formula ( 1 )\end{matrix}$$

If the objective is equally or unequally weighted balance between accuracy and execution time, then the definition of loss function may comprise of classification loss as well as latency, or number of multiplication and addition operations as expressed in formula (2) below.

$$\begin{matrix}[ Math . 2 ] & \\ Loss = {f}_{l} ( classification loss , latency or MACS ) & formula ( 2 )\end{matrix}$$

After evaluating loss using loss function on the output of the FC₁ block 9081, similar process is followed for the remaining FC blocks 9082 to 9083. Finally, B₁^{j} sublayer corresponding to the FC block with optimal loss value is selected as winner as shown by step S502.

Thus, the neural architecture selector 500 selects one of the plurality of candidate layers which corresponds to the best performing one of the plurality of fully-connected layers.

The better the sublayers are able to extract efficient features the greater chances of the corresponding FC block to accurately classify the input images. Hence, it can confidently said that sublayer corresponding to the best performing FC block as compared to other M−1 FC blocks sublayers will best choice among the M sublayers.

In step S503, the neural architecture selector 500 keeps only the winner sublayer and removes remaining M−1 sublayers from the SuperNet. Since the remaining M−1 sublayers are pruned out, B₁ layers are optimized by the end of step S503. The pruned SuperNet having one layer in all N layers, along with other fixed layers 904 in the backbone 901, and with the Neck 902 and the Head 903, is given as the output.

In step S504, the neural architecture selector 500 determines whether the search has completed for all layers in the SuperNet. In a case where the neural architecture selector 500 determines that the search has not completed for all layers in the SuperNet, the process of the step S505 is performed.

In step S505, the neural architecture selector 500 outputs the current SuperNet, which is the pruned SuperNet. That is, the neural architecture selector 500 comprises an outputting means to output pruned supernetwork by a selection process of the neural architecture selector 500.

The process of the step S505 completes the candidate selection procedure for the B₁ layer in the backbone 901 by the neural architecture selector 500 as shown by Step3 S103 in FIG. 8. Also, the neural architecture selector 500 increments the value of the parameter i so as to optimize the next layer. The output SuperNet is provided to the SuperNet builder 300. The process of the step S305 is then performed with the pruned SuperNet.

In a case where the neural architecture selector 500 determines, in the step S504, that the search has completed for all layers in the SuperNet, the process of the step S506 is performed. In step S506, the neural architecture selector 500 outputs the current SuperNet. Since the search has completed for all layers in the SuperNet, it is determined, in step S104 of FIG. 8, that all N layers in the SuperNet are covered. Then, in step S105 of FIG. 8, the SuperNet output from the neural architecture selector 500 is output as the optimized CNN model.

Thus, the process of the neural architecture selector 500 is performed.

### Advantageous Effect of the Second Example Embodiment

According to the second example embodiment, only one target layer is optimized at a time. The neural architecture search can be done quicker in compared to optimization of all layers simultaneously. This makes training time for the SuperNet very efficient.

Also, apart from the one preceding and one succeeding layer of target layer Bᵢ in a particular iteration, all other N−2 including the sublayers in Bᵢ gets trained with one layer as input and one layer as output. Such is generally the architecture structure of output Subnet or output Optimal CNN model. Therefore by optimizing one layer in one iteration, the gap between the architecture structures of SuperNet and Subnet can be significantly reduced.

Moreover, the advantage of such a narrower gap may also cause a reduction of training time of SubNet, thereby further reducing the training time required by NAS based CNN model training system 100.

### Third Example Embodiment

Hereinafter, the third example embodiment will be described with reference to the drawings. In the following descriptions, only differences between the system 100 and the neural architecture searching process according to the second example embodiment and the system 100 and the neural architecture searching process according to the third example embodiment will be described.

Note that the same reference numerals are given to elements having the same functions as those described in the second example embodiment, and descriptions of such elements are omitted as appropriate.

In the second example embodiment, the optimization of the Bi layers are performed in the following order; B₁ layer, B₂ layer, . . . B_{N} layer. However, a random traversing such that 0<i≤N may be done for selecting the target layer.

In this example embodiment, while performing the first iteration, any layer of Bᵢ layers can be optimized. The only constraint is that, in the N times of iterations, all of the Bᵢ layers should be covered.

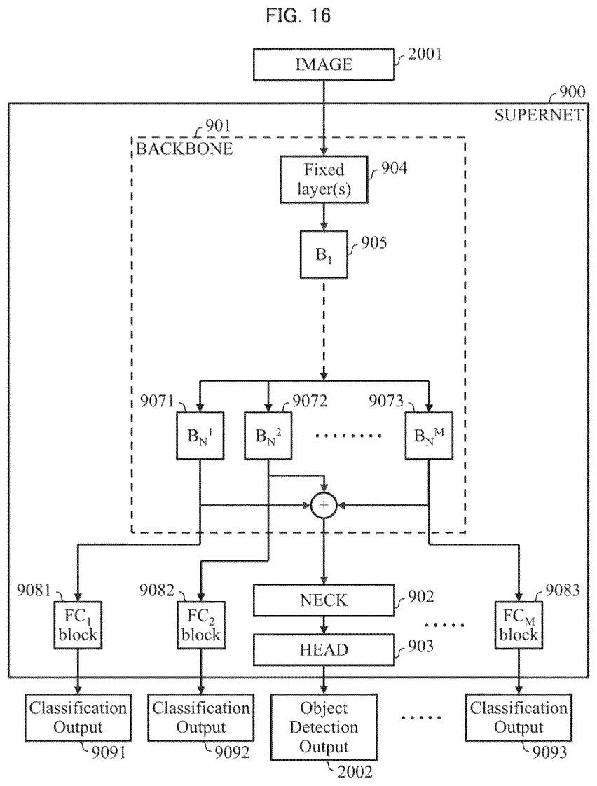

FIG. 16 illustrates the SuperNet CNN model built by SuperNet builder 300 in this example embodiment. The SuperNet CNN model shown in FIG. 16 is built in step S101 of FIG. 8 in the first iteration. In this case, the random traversing has been stated with “N”, which means that the initial value of the parameter i is “N”.

In the example shown in FIG. 16, the optimization of the backbone 901 is started with the B_{N} layer. That is, the B_{N} layer is replaced by M parallel CNN layers (sublayers) first. The plurality of sublayers (B_{N}¹, B_{N}², . . . , B_{N}^{M}) are therefore illustrated at the B_{N} layer. The M FC blocks 9081 to 9083 are respectively connected to the sublayers 9071 to 9073.

Meanwhile, in the second example embodiment, the B₁ layer is replaced by M parallel CNN layers (sublayers) first as shown in FIG. 6.

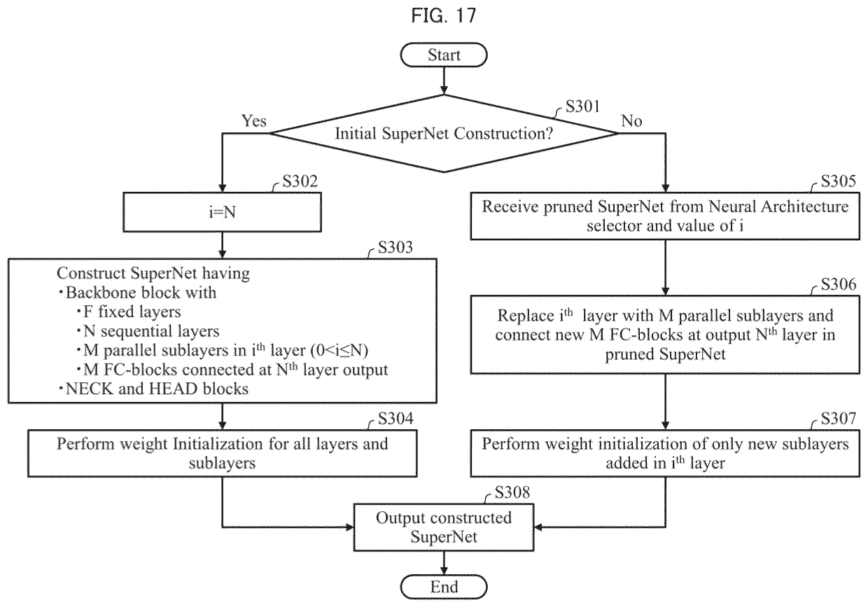

FIG. 17 is a flowchart for illustrating a process performed by the SuperNet builder 300 in this example embodiment.

In step S301 of FIG. 17, the SuperNet builder 300 determines whether the current process is performed as initial SuperNet construction. The initial SuperNet construction corresponds to the first iteration. In a case where the SuperNet builder 300 determines that the current process is performed as initial SuperNet construction, the process of step S302 is performed.

In step S302 of FIG. 17, the SuperNet builder 300 sets the value of the parameter i to be “N”.

Meanwhile, in the second example embodiment, the SuperNet builder 300 sets the value of the parameter i to be “1” as shown in step S302 of FIG. 9.

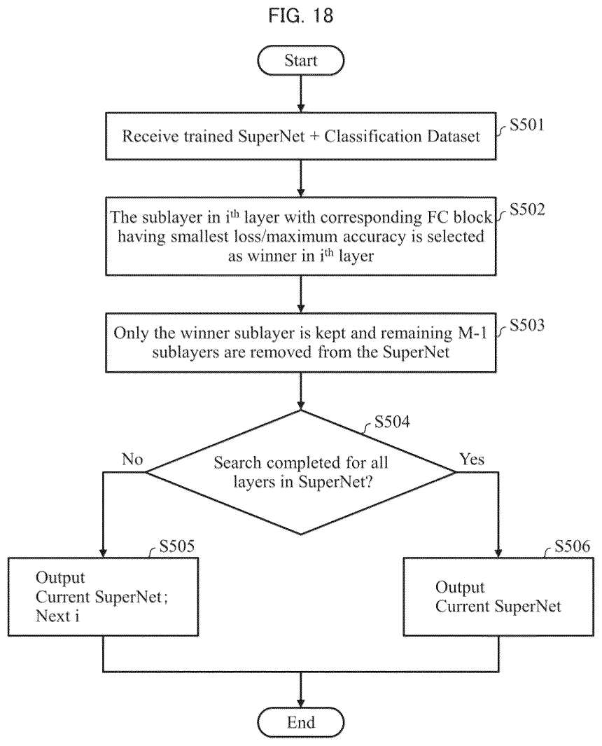

FIG. 18 is a flowchart for explaining a process performed by the neural architecture selector 500 in this example embodiment.

In step S504 of FIG. 18, the neural architecture selector 500 determines whether the search has completed for all layers in the SuperNet. In a case where the neural architecture selector 500 determines that the search has not completed for all layers in the SuperNet, the process of the step S505 is performed.

In step S505 of FIG. 18, the neural architecture selector 500 outputs the current SuperNet, which is the pruned SuperNet. The process of the step S505 completes the candidate selection procedure for the current Bᵢ layer in the backbone 901 by the neural architecture selector 500 as shown by Step3 S103 in FIG. 8. The output SuperNet is provided to the SuperNet builder 300. The process of the step S305 is then performed with the pruned SuperNet.

Also, the neural architecture selector 500 sets the value of the parameter i so as to optimize the next layer. The next layer is also selected by the random traversing. Assuming that the system 100 is performing the first iteration, in which the value of the parameter i is set to be “N”, a value is randomly selected from 1 to N−1 in step S505 of FIG. 18.

Meanwhile, in the second example embodiment, the SuperNet builder 300 sets the value of the parameter i to be “i+1” as shown in step S505 of FIG. 15.

### Advantageous Effect of the Second Example Embodiment

As explained above, the target layer Bᵢ may be randomly selected, thereby improving the flexibility of the optimization.

### Fourth Example Embodiment

Hereinafter, the forth example embodiment will be described with reference to the drawings. In the following descriptions, only differences between the system 100 and the neural architecture searching process according to the second and third example embodiments and the system 100 and the neural architecture searching process according to the fourth example embodiment will be described.

Note that the same reference numerals are given to elements having the same functions as those described in the second and third example embodiments, and descriptions of such elements are omitted as appropriate.

In the second and third example embodiments, the M FC blocks 9081 to 9083 are connected at the output of B_{N} layer 907. However, the M FC blocks may be connected at the output of any Bₗₐₜₑᵣ layer such that i≤later. That is, in this example embodiment, the M FC blocks may be connected to any of Bᵢ layers deeper than or equal to the target layer.

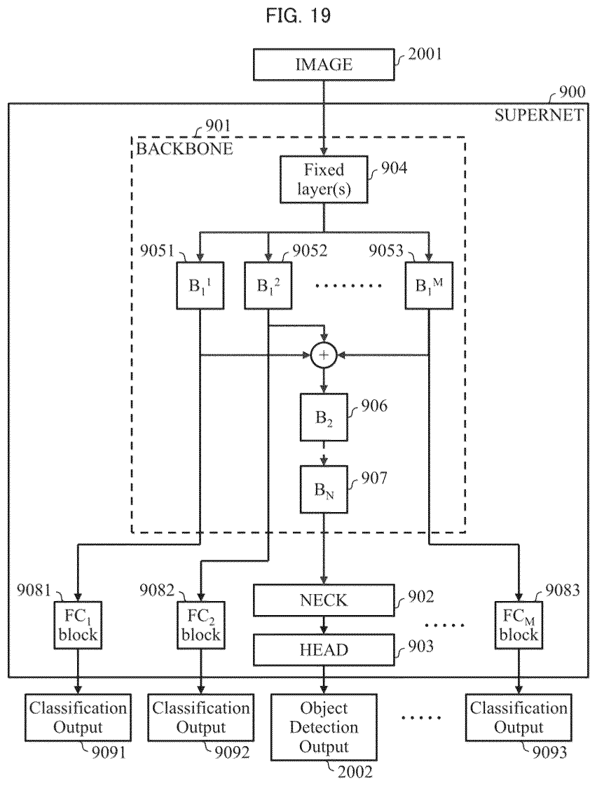

FIG. 19 illustrates the SuperNet CNN model built by SuperNet builder 300 in this example embodiment. The SuperNet CNN model shown in FIG. 19 is built in step S101 of FIG. 8 in the first iteration, where the target layer is B₁ layer.

The plurality of sublayers (B₁¹, B₁², . . . , B₁^{M}) are therefore illustrated at the B₁ layer. The M FC blocks 9081 to 9083 are respectively connected to the sublayers 9051 to 9053. In this case, the M FC blocks are respectively connected at the output of the target layer, which means that the value of the parameter later is equal to the value of the parameter i.

Meanwhile, in the second and the third example embodiments, the M FC blocks are respectively connected at the output of the B_{N} layer irrespective of the layer that is currently selected as the target layer, as shown in FIG. 6 and FIG. 16.

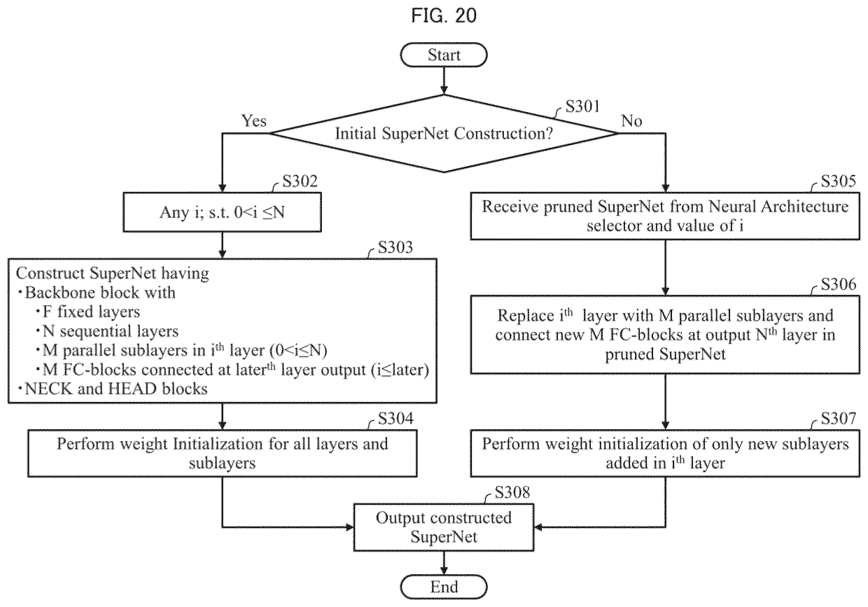

FIG. 20 is a flowchart for illustrating a process performed by the SuperNet builder 300 in this example embodiment.

In step S303 of FIG. 20, the SuperNet builder 300 constructs a SuperNet having the back bone 901 Neck 902, and Head 903, where the backbone 901 having F fixed layers, N sequential layers, M parallel sublayers in ith layer (0<i≤N) M FC-blocks connected at later^{th} layer output (i≤later).

Meanwhile, in the second and third embodiment, the SuperNet builder 300 constructs a SuperNet having the back bone 901 Neck 902, and Head 903, where the backbone 901 having F fixed layers, N sequential layers, M parallel sublayers in i^{th} layer (0<i≤N) M FC-blocks connected at N^{th} layer output as shown in step 303 of FIG. 9 and step 303 of FIG. 17.

### Advantageous Effect of the Fourth Example Embodiment

As explained above, the M FC blocks may be connected to any of Bᵢ layers deeper than or equal to the target layer, thereby improving the flexibility of the optimization.

### (Example of Configuration Achieved by Software)

One or some of or all of the functions of the system 100 can be realized by hardware such as an integrated circuit (IC chip) or can be alternatively realized by software.

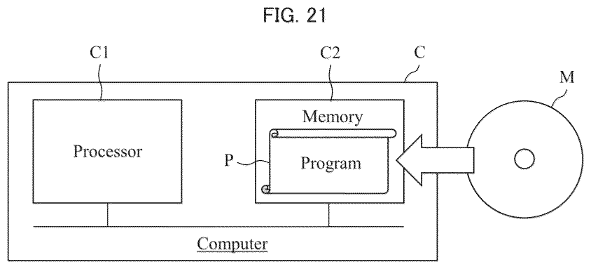

In the latter case, the system 100 is realized by, for example, a computer that executes instructions of a program that is software realizing the foregoing functions. FIG. 21 illustrates an example of such a computer (hereinafter, referred to as “computer C”). The computer C includes at least one processor C1 and at least one memory C2. The memory C2 stores a program P for causing the computer C to function as the system 100. In the computer C, the processor C1 reads the program P from the memory C2 and executes the program P, so that the functions of the system 100 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other devices. The computer C can further include an input-output interface for connecting input-output devices such as a keyboard, a mouse, a display, and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by properly combining technical means disclosed in the foregoing example embodiments.

### [Additional Remark 2]

The whole or part of the example embodiments disclosed above can be described as follows. Note, however, that the present invention is not limited to the following example aspects.

### [Supplementary Notes]

Aspects of the present invention can also be expressed as follows:

### (Aspect 1)

A neural architecture searching apparatus comprising:
building means to build a supernetwork, wherein a target layer of the supernetwork to be optimized is replaced by a plurality of candidate layers, and the supernetwork comprises a plurality of fully-connected layers;
training means to train the supernetwork, wherein the plurality of candidate layers are trained part by part, and the plurality of fully-connected layers are trained correspondingly to the part of the plurality of candidate layers; and
selecting means to evaluate the trained supernetwork and select a part of the plurality of candidate layers which corresponds to the best performing part of the plurality of fully-connected layers.

### (Aspect 2)

The neural architecture searching apparatus according to aspect 1, wherein
in a training process by the training means, the plurality of candidate layers are trained one by one, and the plurality of fully-connected layers are trained correspondingly to the one of the plurality of candidate layers, and
the selecting means selects one of the plurality of candidate layers which corresponds to the best performing one of the plurality of fully-connected layers.

### (Aspect 3)

The neural architecture searching apparatus according to aspect 1 or 2, wherein
the plurality of fully-connected layers are connected to an output of the target layer or any deeper layer compared to the target layer.

### (Aspect 4)

The neural architecture searching apparatus according to any one of aspects 1 to 3, wherein
the training means trains the supernetwork for at least one of:
   an object detection task by using object detection dataset, and
   and classification task by using classification dataset.

### (Aspect 5)

The neural architecture searching apparatus according to aspect 4, further comprising
transforming means to transform the object detection dataset to the classification dataset.

### (Aspect 6)

The neural architecture searching apparatus according to any one of aspects 1 to 5, wherein
the supernetwork comprises a backbone block, a neck block and a head block,
the backbone block comprises a plurality of sequentially arranged CNN layers and the plurality of fully-connected layers, and
the target layer is selected from the plurality of sequentially arranged CNN layers.

### (Aspect 7)

The neural architecture searching apparatus according to any one of aspects 1 to 6, further comprising
outputting means to output pruned supernetwork by a selection process of the selection means.

### (Aspect 8)

A neural architecture searching method comprising:
building a supernetwork, wherein a target layer of the supernetwork to be optimized is replaced by a plurality of candidate layers, and the supernetwork comprises a plurality of fully-connected layers;
training the supernetwork, wherein the plurality of candidate layers are trained part by part, and the plurality of fully-connected layers are trained correspondingly to the part of the plurality of candidate layers; and
evaluating the trained supernetwork and selecting a part of the plurality of candidate layers which corresponds to the best performing part of the plurality of fully-connected layers.

### (Aspect 9)

A program for causing a computer to serve as the neural architecture searching apparatus according to aspect 1, said program causing the computer to serve as the building means, the training means, and the selecting means.

### REFERENCE SIGNS LIST

| | |
|---|---|
| 1 | Neural architecture searching apparatus |
| 11 | building section |
| 12 | training section |
| 13 | selecting section |
| 100 | neural architecture search based CNN model training system |
| 200 | Training Dataset for Object Detection task |
| 300 | SuperNet builder |
| 400 | SuperNet Trainer with Object detection task & Classification task |
| 500 | Neural Architecture selector |
| 600 | Dataset Transformer |
| 700 | Training Dataset for Classification task |
| 800 | Optimized CNN model |
| 900 | SuperNet |
| 901 | Backbone |
| 902 | Neck |
| 903 | Head |

What is claimed is:

1. A neural architecture searching apparatus comprising at least one processor, the at least one processor carrying out:
a building process of building a supernetwork, wherein a target layer of the supernetwork to be optimized is replaced by a plurality of candidate layers, and the supernetwork comprises a plurality of fully-connected layers;
a training process of training the supernetwork, wherein the plurality of candidate layers are trained part by part, and the plurality of fully-connected layers are trained correspondingly to the part of the plurality of candidate layers; and
a selecting process of evaluating the trained supernetwork and selecting a part of the plurality of candidate layers which corresponds to the best performing part of the plurality of fully-connected layers.

2. The neural architecture searching apparatus according to claim 1, wherein
in the training process, the plurality of candidate layers are trained one by one, and the plurality of fully-connected layers are trained correspondingly to the one of the plurality of candidate layers, and
in the selecting process, the at least one processor selects one of the plurality of candidate layers which corresponds to the best performing one of the plurality of fully-connected layers.

3. The neural architecture searching apparatus according to claim 1, wherein
the plurality of fully-connected layers are connected to an output of the target layer or any deeper layer compared to the target layer.

4. The neural architecture searching apparatus according to claim 1, wherein
in the training process, the at least one processor trains the supernetwork for at least one selected from the group consisting of:
an object detection task by using object detection dataset, and
and classification task by using classification dataset.

5. The neural architecture searching apparatus according to claim 4, the at least one processor further carrying out
a transforming process of transforming the object detection dataset to the classification dataset.

6. The neural architecture searching apparatus according to claim 1, wherein
the supernetwork comprises a backbone block, a neck block and a head block,
the backbone block comprises a plurality of sequentially arranged CNN layers and the plurality of fully-connected layers, and
the target layer is selected from the plurality of sequentially arranged CNN layers.

7. The neural architecture searching apparatus according to claim 1, the at least one processor further carrying out
a outputting process of outputting pruned supernetwork by the selection process.

8. A neural architecture searching method comprising:
building a supernetwork, wherein a target layer of the supernetwork to be optimized is replaced by a plurality of candidate layers, and the supernetwork comprises a plurality of fully-connected layers;
training the supernetwork, wherein the plurality of candidate layers are trained part by part, and the plurality of fully-connected layers are trained correspondingly to the part of the plurality of candidate layers; and
evaluating the trained supernetwork and selecting a part of the plurality of candidate layers which corresponds to the best performing part of the plurality of fully-connected layers.

9. A non-transitory storage medium storing a program for causing a computer to serve as the neural architecture searching apparatus according to claim 1, said program causing the computer to carry out the building process, the training process, and the selecting process.
